(19) United States
(12) Patent Application Publication
(10) Pub. No.: US 2022/0324145 A1
(43) Pub. Date: Oct. 13, 2022

(54) PLASTICIZING UNIT FOR A SHAPING MACHINE AND METHOD FOR OPERATING OF SUCH ONE

(71) Applicant: ENGEL AUSTRIA GmbH, Schwertberg (AT)

(72) Inventor: Guenther KLAMMER, Aschbach Markt (AT)

(21) Appl. No.: 17/714,389

(22) Filed: Apr. 6, 2022

(30) Foreign Application Priority Data
Apr. 7, 2021 (AT) A 50253/2021

(51) Int. Cl. B29C 45/53; B29C 45/47

(52) U.S. Cl. CPC B29C 45/53; B29C 45/47

(57) ABSTRACT

A plasticizing unit for a shaping machine for plasticizing a material to be plasticized, wherein at least one plasticizing screw is rotatably mounted in a plasticizing cylinder and stationarily mounted in relation to a longitudinal axis of the plasticizing cylinder, wherein the plasticizing cylinder has at least one opening at a periphery of the plasticizing cylinder, and that at least one opening connects the plasticizing cylinder to at least one mass storage means, and that there is provided an actuator for expelling a storage mass which can be stored in the at least one mass storage means.

### BACKGROUND OF THE INVENTION

The present invention concerns a plasticizing unit for a shaping machine having the features of the classifying portion of claim 1, a shaping machine comprising such a plasticizing unit and a method of operating such a plasticizing unit.

The term shaping machines can be used to denote injection molding machines, injection presses, presses and the like. Shaping machines in which the plasticized material is fed to an open mold tool can certainly also be imagined.

The state of the art is to be outlined hereinafter by reference to an injection molding machine. Similar considerations apply generally to shaping machines.

Plasticizing units of the general kind set forth for injection molding machines for plasticizing a material to be plasticized have at least one plasticizing screw, wherein the at least one plasticizing screw is mounted rotatably in a plasticizing cylinder and stationarily in relation to a longitudinal axis of the plasticizing cylinder.

In the state of the art, such plasticizing units are often also referred to as plasticizing extruders or compounders and are also often used in recycling applications.

In this case a material to be plasticized is continuously plasticized and conveyed by at least one plasticizing screw.

As, however, injection molding machines (and shaping machines in general) are mostly operated discontinuously in cycles, that plasticized material is then collected in an injection cylinder until a desired injection mass is reached and injected by the injection cylinder within an injection cycle (mostly into a mold tool).

During injection it is, however, not possible for the plasticizing unit to continue feeding plasticized material to the injection cylinder, which is why it is known from the state of the art during the injection cycle to shut down the plasticizing unit or the rotation of the at least one plasticizing screw until feeding the plasticized material into the injection unit is possible again.

That, however, has the disadvantage that the plasticizing unit is operated discontinuously which in part leads to hardening of the plasticized material in the plasticizing unit and has a detrimental effect on the quality of the plasticized material.

In addition, that results in a disadvantage in relation to the process cycle time, as the discontinuous operation of the plasticizing unit leads to loss in time during which a material to be plasticized could have already been plasticized for a subsequent cycle.

It is therefore also known from the state of the art to arrange mass storage means between an injection unit and a plasticizing unit of an injection molding machine so that the plasticizing unit can be operated continuously and conveys plasticized material into the mass storage means during an injection cycle, wherein the mass storage means expels the stored plasticized material and feeds it to the injection unit, as soon as that is possible on the part of the injection unit.

That considerably increases the cycle time of an injection molding machine, as a material to be plasticized can also be plasticized during the injection cycle of the injection molding machine.

However, as regards the mass storage means between the plasticizing unit and the injection unit, it turned out to have the negative effect that deposits of the plasticized material to be hardened occur during the storage operation, wherein the deposits accumulate in the mass storage means or the subsequent connecting conduit between the mass storage means and the injection unit, which in turn, of course, can have an adverse effect on the operating properties of the injection molding machine.

In addition, those deposits and/or hardenings have an adverse effect on a quality of a product to be produced.

\

### SUMMARY OF THE INVENTION

The object of the present invention is to provide a plasticizing unit for a shaping machine as well as a shaping machine comprising such a plasticizing unit and a method for operating such a plasticizing unit which represents an improved solution over the state of the art and/or represents a more efficient possible way of continuous plasticization and/or ensures trouble-free operation by virtue of deposits in relation to the state of the art and/or allows higher qualities of a product.

This object is attained by a plasticizing unit for a shaping machine for plasticizing a material to be plasticized having the features of claim 1, a shaping machine comprising such a plasticizing unit and a method for operating such a plasticizing unit.

According to the invention, it is provided that at least one plasticizing screw is rotatably mounted in a plasticizing cylinder and stationarily mounted in relation to a longitudinal axis of the plasticizing cylinder, wherein the plasticizing cylinder has at least one opening at a periphery of the plasticizing cylinder, and that at least one opening connects the plasticizing cylinder to at least one mass storage means, and it is provided that there is an actuator for expelling a storage mass stored in the at least one mass storage means.

As a mass storage means is provided, it is possible to continuously operate the plasticizing unit, wherein plasticized material can be stored in the mass storage means and the plasticized material from the mass storage means can be discharged continuously out of the plasticizing unit together with plasticized material of the at least one plasticizing screw.

By way of the at least one opening in the plasticizing cylinder, it is possible to feed plasticized material by the at least one plasticizing screw directly out of the plasticizing cylinder to the mass storage means.

The storage mass (the stored plasticized material) can be expelled from that mass storage means using the actuator and can be fed back into the plasticizing cylinder by way of the at least one opening, wherein same can be further passed out of the plasticizing cylinder to the shaping machine.

That has the advantage that the storage mass after storage again passes through the plasticizing cylinder, by which the stored material comes into contact with further plasticized material and mixes therewith, through which the storage mass is heated once again, which reduces the risk of deposits due to cooling down the plasticized material. In addition, the storage mass is once again heated when passing through the plasticizing cylinder.

A further advantage is that the entire stored material is pushed out of the mass storage means into the plasticizing cylinder, wherein deposits or hardenings formed in the mass storage means also again pass into the plasticizing cylinder and again can there be plasticized, wherein an automatic cleaning of the mass storage means is implemented (wherein, so-to-speak, the impurities and/or deposits of the mass storage means are recycled in the plasticizing cylinder).

An apparatus according to the invention or a method according to the invention can also be used and subsequently installed in already known configurations of the state of the art, as mentioned for example in the preamble to the description herein.

The term shaping machines can be used to denote injection molding machines, injection presses, presses and the like. Shaping machines in which the plasticized material is fed to an open mold tool are in principle certainly conceivable.

In accordance with the invention, more than one mass storage means can be provided which is/are connected to the plasticizing cylinder by way of one or more openings.

It is possible to provide more than one actuator for expelling the storage mass from one or more mass storage means.

Advantageous embodiments of the invention are defined by means of the appendant claims.

It can be provided that the plasticizing unit has at least one discharge opening, wherein the plasticized material can be discharged from the plasticizing unit by way of the at least one discharge opening, wherein the at least one discharge opening is provided spaced from the at least one opening.

It can be provided that the at least one discharge opening is provided at one end of the plasticizing cylinder along an axis of rotation of the at least one plasticizing screw. The at least one discharge opening can be for example in the form of a nozzle.

It can be provided that the at least one discharge opening has a valve, wherein the plasticized material can be prevented from flowing back into the plasticizing cylinder for example by way of a back-flow blocking means. By such a valve discharging the plasticized material out of the plasticizing cylinder by way of the at least one discharge opening can be open-loop or closed-loop controlled. A similar consideration applies to a three-way or four-way valve which possibly has a blocking position.

It can be provided that the plasticizing unit has a feed device, wherein the material to be plasticized can be fed to the plasticizing unit by way of the feed device, wherein the feed device is configured spaced from the at least one opening.

It can be provided that the feed device is provided as a further opening in the plasticizing cylinder, wherein a material to be plasticized is fed in a rear screw intake region to the at least one plasticizing screw. Such feed devices can for example have a feed hopper for the feed of a granular material.

It is however also certainly conceivable that a material which has already been at least partially plasticized is fed to the plasticizing unit, wherein that material that has already been at least partially plasticized is further plasticized by the plasticizing unit.

It can also be provided that there are several feed devices, wherein the plasticizing unit can be adapted to plasticize those (possibly different) materials to be plasticized and to blend them together.

It is preferably provided that the at least one mass storage means is in the form of a piston-cylinder unit. Thus it can be provided that the mass storage means has a piston guided in a cylinder and can vary its storage space in terms of its volume by movement of the piston in the cylinder.

It can be provided that the at least one opening is of substantially the same dimensions as the internal dimensions of the piston-cylinder unit.

It can be provided for example that the piston-cylinder unit (which forms the mass storage means) directly joins the plasticizing cylinder, wherein it can preferably be provided that a longitudinal axis of the piston-cylinder unit, in which the direction of movement of the piston is provided, is normal to an axis of rotation and/or central axis of the at least one plasticizing screw and/or of the plasticizing cylinder.

It is preferably provided that a piston of the piston-cylinder unit is adapted to an internal contour of the plasticizing cylinder, wherein in an extended position of the piston-cylinder unit the piston closes the at least one opening.

Accordingly, it can be provided that the piston of the piston-cylinder unit, in an extended position, completes an inner peripheral surface of the plasticizing cylinder, wherein the at least one opening in the plasticizing cylinder is completely closed.

It can be provided that a piston of the piston-cylinder unit is adapted to an external geometry of the at least one plasticizing screw, wherein in an extended position of the piston-cylinder unit the piston joins the at least one plasticizing screw.

In that case, preferably the rotation of the at least one plasticizing screw is to be taken into account. Particularly preferably, the piston is therefore adapted to the contour of the notional rotational body which is produced by the rotation of the at least one plasticizing screw. This applies to embodiments with a single plasticizing screw as well as also embodiments having two or more plasticizing screws.

In principle, it would however also be conceivable that the contour of the end face of the piston is adapted to the geometry of the plasticizing screw in a given rotational position, wherein the rotation of the at least one plasticizing screw is stopped when the piston is in the extended position. This applies to embodiments with a single plasticizing screw as well as also embodiments having two or more plasticizing screws.

That gives the substantial advantage that—if the piston is also adapted to an external geometry of the at least one plasticizing screw—in an extended state, the end face of the piston of the piston-cylinder unit can be cleaned by the at least one plasticizing screw by the at least one plasticizing screw directly joining the piston. This way deposits and impurities which settle at an end face of the piston can be sheared off by the at least one plasticizing screw.

In such a procedure, the piston of the piston-cylinder unit (which serves as mass storage means) is moved with the extension movement to the at least one plasticizing screw until it almost touches the plasticizing screw with its end face (preferably, until there is only a spacing of 0.05 to 1 mm left between the piston and the plasticizing screw) and there is only a small gap remaining between the piston and the plasticizing screw. This small gap can, of course, also be configured such that the plasticizing screw at least temporarily touches the piston in order to shearingly clean the piston.

It is preferably provided that in an extended state the piston of the piston-cylinder unit joins flush with the at least one opening of the plasticizing cylinder with the end face of the piston.

It can be provided that a piston of the piston-cylinder unit and the at least one opening is of a diameter which is in a ratio to a diameter of the at least one plasticizing screw of 0.5 to 1.1, preferably 0.8 to 1, particularly preferably 0.9.

It can be provided that the at least one plasticizing screw is in the form of an individual plasticizing screw or in the form of a double-screw extruder.

It can be provided that at the periphery of the plasticizing cylinder the plasticizing cylinder has at least one further opening, and the at least one further opening connects the plasticizing cylinder to at least one further mass storage means, and that there is provided a further actuator for expelling a storage mass which can be stored in the at least one mass storage means, wherein preferably a longitudinal axis of the at least one further mass storage means and a longitudinal axis of the mass storage means are at an angle of 0° to 180° to each other. Preferably, this angle can be between 20° and 120°, particularly preferably between 40° and 80°.

Alternatively or in addition, several mass storage means can also be arranged in an axially displaced relationship on the plasticizing cylinder.

It is preferably provided that the at least one opening on the plasticizing cylinder is spaced from one end of the plasticizing cylinder, at which preferably the at least one discharge opening is arranged, by 0.2 to 4 times a diameter of the at least one plasticizing screw.

It can be provided that the mass storage means has a hydraulic and/or electrical actuation. This hydraulic and/or electrical actuation can directly or also indirectly (for example by way of a transmission gear) drive the actuator to expel the storage mass which can be stored in the at least one mass storage means.

It is preferably provided that there is at least one temperature-control device, preferably a heating device, wherein the at least one temperature-control device is adapted to temperature control a storage mass which can be stored in the at least one mass storage means. By virtue of a temperature-control device it can for example be provided that a plasticized material in the material cylinder is brought to or kept at a desired temperature in order to preferably prevent hardening of the plasticized material. Alternatively or additionally, temperature control of the actuator can also be provided.

It can be provided that the actuator is adapted to specifically increase a volume of the at least one mass storage means for the feed of the plasticized material so that plasticized material can be conveyed out of the plasticizing cylinder by way of the at least one opening.

An open-loop and/or closed-loop control unit adapted to actuate the actuator can be provided.

In particular, the open-loop and/or closed-loop control unit can operate the actuator in such way that for feed of the plasticized material a volume of the at least one mass storage means is specifically increased so that plasticized material can be conveyed out of the plasticizing cylinder by way of the at least one opening.

Furthermore, protection is sought for a method to operate a plasticizing unit according to the invention including the following steps:
continuously plasticizing a material to be plasticized using the at least one plasticizing screw,
feeding plasticized material by way of the at least one opening in the plasticizing cylinder into the at least one mass storage means, and
expelling the storage mass out of the at least one mass storage means using the actuator, wherein plasticized material is expelled from the plasticizing unit.

It is preferably provided that the actuator for feed of the plasticized material is actuated to increase a volume of the at least one mass storage means so that plasticized material is conveyed out of the plasticizing cylinder by way of the at least one opening into the mass storage means (possibly by a generated underpressure).

It can preferably be provided that the actuator is actuated during the feed of the plasticized material in such way that substantially no plasticized material leaks from the plasticizing unit during a period of time of the feed (for example by way of the discharge opening).

Consequently, it can be provided that the actuator is actuated in such way that a plasticized material is sucked or conveyed out of the plasticizing cylinder by way of the at least one opening, wherein the entire material plasticized by the at least one plasticizing screw is at least temporarily conveyed into the mass storage means.

That can give the advantage that during filling of the mass storage means, no plasticized material leaks from the plasticizing unit so that for example components following on from the plasticizing unit (in relation to a delivery direction of the plasticized material) can be cleaned or replaced without the plasticizing unit having to be closed off from those components by a separate valve.

For example, it can therefore be provided that a filter following the plasticizing unit (preferably a melt filter) can be replaced or cleaned during filling of the mass storage means in full operation of the plasticizing unit, as the material plasticized by the at least one plasticizing screw is received by the mass storage means and thus the filter to be cleaned is relieved of load.

It can also be provided that actuation of the actuator is effected in such way that plasticized material which has already been expelled from a subsequent component of the plasticizing unit is drawn back into the plasticizing cylinder. This can for example be used if a filter following the plasticizing unit has impurities or deposits, wherein those deposits or impurities can be drawn back into the plasticizing unit by actuation of the actuator of the mass storage means in order to clean the filter.

An open-loop or closed-loop control unit for open-loop or closed-loop control of the at least one plasticizing screw and/or the actuator can be provided.

By virtue of their rotation, plasticizing screws usually cause shearing in the material to be plasticized, which leads to energy being deposited in the material, and to plasticization of the material. This procedure can be supported by heating of the plasticizing cylinder.

### BRIEF DESCRIPTION OF THE DRAWINGS

Further examples, advantages and details of the invention are illustrated in the specific description hereinafter and in the Figures in which:

FIGS. 1a and 1b show a first embodiment of a plasticizing unit according to the invention,

FIGS. 2a and 2b show a second embodiment of a plasticizing unit according to the invention,

FIG. 3 shows a third embodiment of a plasticizing unit according to the invention, and

FIG. 4 shows a fourth embodiment of a plasticizing unit according to the invention.

### DETAILED DESCRIPTION OF THE INVENTION

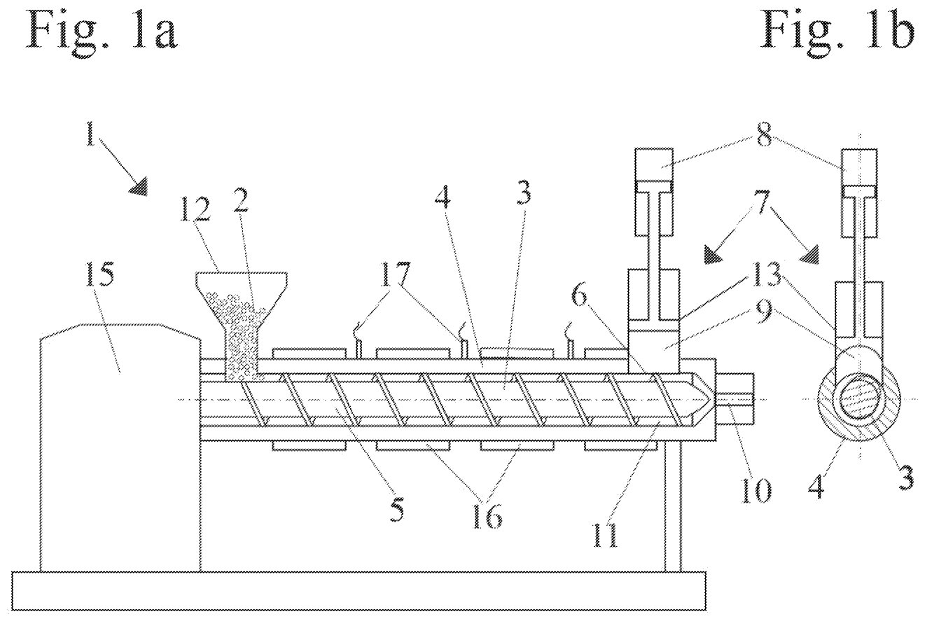

FIGS. 1a and 1b show a first embodiment of a plasticizing unit 1 according to the invention, with the plasticizing unit comprising a plasticizing screw 3 arranged in the plasticizing cylinder 4.

The plasticizing screw 3 can be driven in rotation by a rotary drive 15 in the plasticizing cylinder 4 to plasticize a material 2 to be plasticized.

In this embodiment, the plasticizing screw 3 is mounted stationarily along the longitudinal axis 5 of the plasticizing cylinder 4 and carries out a continuous plasticization of the material 2 to be plasticized.

A material 2 to be plasticized is fed to the plasticizing unit 1 by way of the feed device 12 in the form of a feed hopper, wherein the plasticizing screw 3, along its screw flights, then plasticizes the material 2 to be plasticized by the rotation and the shearing heat generated thereby.

In addition, arranged along the longitudinal axis 5 of the plasticizing cylinder 4 are heating bands 16 which promote additional heating and thus plasticization of the material 2 to be plasticized.

The plasticization can be monitored and if needed closed-loop controlled by way of sensors 17 (temperature sensors).

The plasticized material 11 can then be discharged from the plasticizing unit 1 by way of the discharge opening 10 of the plasticizing unit 1, with the discharge opening being arranged at an end of the plasticizing cylinder 4, that faces away from the rotary drive 15.

In addition, the plasticizing cylinder 4 has an opening 6 at the periphery of the plasticizing cylinder 4, with that opening connecting the plasticizing cylinder 4 to a mass storage means 7.

That opening 6 is arranged at the periphery of the plasticizing cylinder 4 in a region of the discharge opening 10, wherein material 11 which has already been plasticized can pass into the mass storage means 7.

The storage mass 9 (plasticized material 11) which is stored in the mass storage means 7 can be expelled by way of the actuator 8 which in this embodiment is in the form of a hydraulic cylinder.

The mass storage means 7 in this embodiment is in the form of a piston-cylinder unit having a piston 13, with a volume of the mass storage means 7 being variable by way of the piston 13 by means of the actuator 8.

FIG. 1a shows a side view of the plasticizing unit 1 and FIG. 1b shows a section through the plasticizing cylinder 4 and the mass storage means 7.

The plasticizing screw 3 of the embodiment in FIGS. 1a and 1b is in the form of a single plasticizing screw 3.

The mass storage means 7 is connected directly to the opening 6 of the plasticizing cylinder 4, with the opening 6 being spaced by 0.5 times the diameter of the plasticizing screw 3 from one end of the plasticizing cylinder 4 at which the discharge opening 10 is arranged.

In operation mode of the plasticizing unit 1 material 2 to be plasticized can now be continuously plasticized by way of the plasticizing screw 3 and fed to the mass storage means 7, wherein the volume of the mass storage means 7 can be increased by specifica open-loop or closed-loop control of the actuator 8 in such way that the material plasticized by the plasticizing screw 3 is guided or drawn by an underpressure into the mass storage means 7.

As soon as the mass storage means has received a defined storage mass 9 of plasticized material 11, the storage mass 9 can be expelled again by way of the actuator 8 and be driven back into the plasticizing cylinder 4, with that plasticized material 11 (or storage mass 9) being expelled by way of the discharge opening 10.

By virtue of such a procedure, in spite of continuous plasticization of the plasticizing unit 1, discontinuous expulsion of plasticized material 11 through the discharge opening 10 can take place.

As can be seen from FIG. 1b, the diameter of the piston-cylinder unit is adapted to the diameter of the opening 6 so that the opening 6 transitions almost seamlessly into the cylinder of the piston-cylinder unit of the mass storage means 7.

The piston 13 of the piston-cylinder unit of the mass storage means 7 is of the same dimensions as the internal dimensions of the plasticizing cylinder 4 so that—when the piston 13 of the mass storage means 7 is in an extended position—it joins the inner peripheral surface of the plasticizing cylinder 4 and embraces the plasticizing screw 3 (as can be seen from FIG. 1b).

The piston 13 of the piston-cylinder unit is adapted to an external geometry of the plasticizing screw 3, the piston 13 fitting to the plasticizing screw 3 in the extended position of the piston-cylinder unit.

This therefore creates the possibility that, when the piston 13 completely expels the mass storage means 7, all residues and deposits from the mass storage means 7 accumulate at the end face of the piston 13 as well, with the geometrical configuration of that end face of the piston 13 and the approach movement of the piston 13 to the plasticizing screw 3 providing that the end face of the piston 13 is shearingly cleaned by the plasticizing screw 3.

This therefore provides that the mass storage means 7 cleans itself by suitable open-loop or closed-loop control, possibly in each cycle.

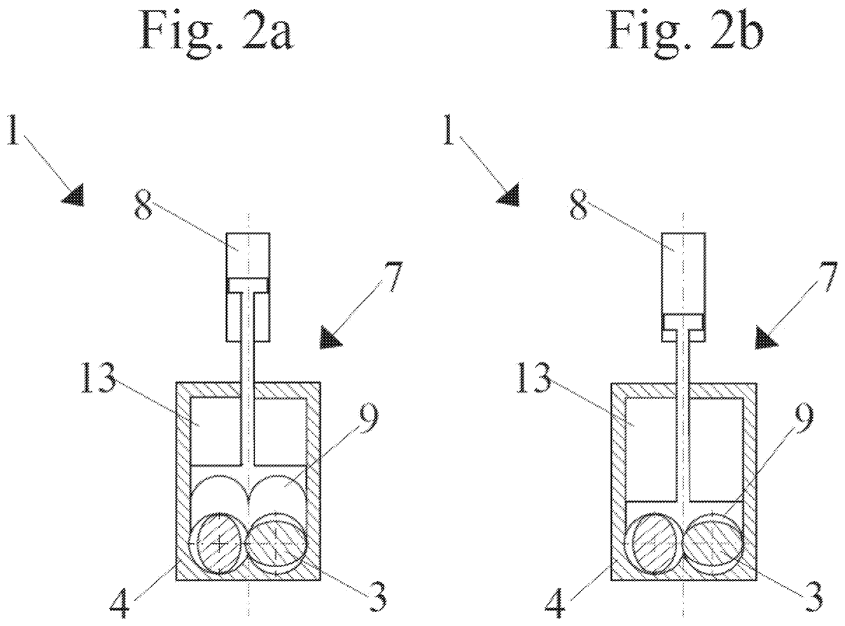

FIGS. 2a and 2b show a second embodiment of a plasticizing unit 1 according to the invention, wherein there is a double screw extruder 14 having two plasticizing screws 3 rotating in opposite relationship.

Here, too, the mass storage means 7 is again provided by a piston-cylinder unit, wherein the piston 13 is adapted to the geometrical configuration of the double-screw extruder 14.

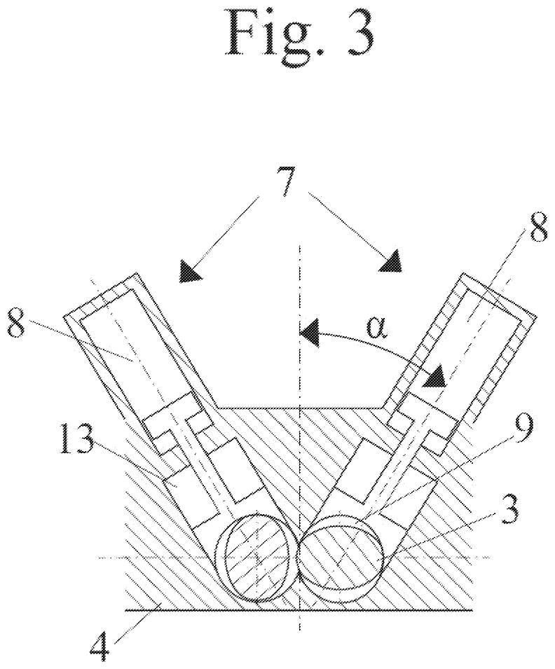

FIG. 3 shows a third embodiment of a plasticizing unit 1 according to the invention, wherein there is once again provided a double-screw extruder 14 having two plasticizing screws 3 rotating in opposite relationship.

In this case, however, there are two mass storage means 7 (the mass storage means and a further mass storage means), wherein respectively one mass storage means 7 connects to respectively one opening 6 in the plasticizing cylinder 4.

The openings 6 (the opening and the further opening) of the plasticizing cylinder 4 are arranged in such way that they each can be associated with a respective plasticizing screw 3 of the double-screw extruder 14.

The mass storage means 7 each are again provided by a piston-cylinder unit, with the piston 13 being adapted to the geometrical configuration of the double-screw extruder 14.

The mass storage means 7 are at an angle 2α of about 60° relative to each other, with their longitudinal extents.

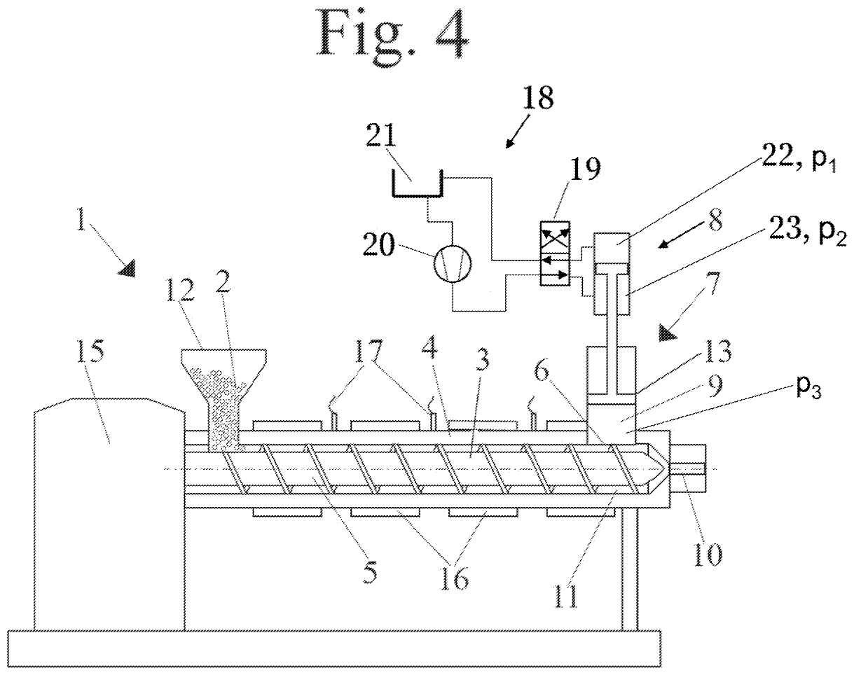

FIG. 4 shows an embodiment according to the invention of a plasticizing unit 1 which substantially corresponds to FIG. 1 but shows the actuator 8 and its open-loop or closed-loop control in a somewhat higher degree of detail.

The actuator in FIG. 4 for actuation of the mass storage means 7 is in the form of a hydraulic cylinder, a hydraulic piston subdividing the hydraulic cylinder into a first chamber 22 and a second chamber 23.

The chambers 22, 23 of the actuator are connected to the hydraulic system 18, by means of which a pressure p₁ in the first chamber 22 and/or a pressure p₂ in the second chamber can be varied, wherein the piston can be moved by different pressures p₁ and p₂ (having regard to the respective piston areas) and thus serves as the actuator 8 for the mass storage means 7 and can exert a corresponding pressure on the storage mass 9 in the mass storage means 7.

The hydraulic system for open-loop or closed-loop control of the actuator has a pump 20, a tank 21 and a hydraulic valve 19.

In the specific example in FIG. 4, a pressure p₂ can be built up in the first chamber 22 by way of the illustrated position of the hydraulic valve 19 by means of the pump 20 through which the volume of the mass storage means 7 increases and plasticized material 11 can be conveyed out of the plasticizing cylinder 4 into the mass storage means 7.

Such a procedure provides that the material conveyed by the plasticizing screw 3 is preferably completely accommodated in the mass storage means 7 and particularly preferably the volume in the mass storage means 7 increases more quickly than the subsequently conveyed plasticized material 11 in the plasticizing cylinder.

This way a reduced pressure can be created for the plasticized material 11 in the mass storage means 7 and discharge of a plasticized material 11 by way of the discharge opening can be stopped or even reversed.

### LIST OF REFERENCES

1 plasticizing unit
2 material to be plasticized
3 plasticizing screw
4 plasticizing cylinder
5 longitudinal axis of the plasticizing cylinder
6 opening
7 mass storage means
8 actuator
9 storage mass
10 discharge opening
11 plasticized material
12 feed device
13 piston
14 double-screw extruder
15 rotary drive
16 heating band
17 sensor
18 hydraulic system
19 hydraulic valve
20 pump
21 tank
22 first chamber
23 second chamber
α angle
p₁ pressure in the first chamber
p₂ pressure in the second chamber
p₃ pressure in the storage mass

1. A plasticizing unit for a shaping machine for plasticizing a material to be plasticized, wherein at least one plasticizing screw is rotatably mounted in a plasticizing cylinder and stationarily mounted in relation to a longitudinal axis of the plasticizing cylinder, wherein the plasticizing cylinder has at least one opening at a periphery of the plasticizing cylinder, and that at least one opening connects the plasticizing cylinder to at least one mass storage means, and that there is provided an actuator for expelling a storage mass which can be stored in the at least one mass storage means.

2. A plasticizing unit as set forth in claim 1, wherein the plasticizing unit has at least one discharge opening, wherein a plasticized material can be discharged from the plasticizing unit by way of the at least one discharge opening, wherein the at least one discharge opening is configured spaced from the at least one opening.

3. A plasticizing unit as set forth in claim 1, wherein the plasticizing unit has a feed device, wherein the material to be plasticized can be fed to the plasticizing unit by way of the feed device, with the feed device being configured spaced from the at least one opening.

4. A plasticizing unit as set forth in claim 1, wherein the at least one mass storage means is in the form of a piston-cylinder unit.

5. A plasticizing unit as set forth in claim 4, wherein the at least one opening is substantially of the same dimensions as the internal dimensions of the piston-cylinder unit.

6. A plasticizing unit as set forth in claim 4, wherein a piston of the piston-cylinder unit is adapted to an internal contour of the plasticizing cylinder, wherein, in an extended position of the piston-cylinder unit, the piston closes the at least one opening.

7. A plasticizing unit as set forth in claim 4, wherein a piston of the piston-cylinder unit is adapted to an external geometry of the at least one plasticizing screw, wherein in an extended position of the piston-cylinder unit the piston joins the at least one plasticizing screw.

8. A plasticizing unit as set forth in claim 4, wherein the at least one opening and/or preferably a piston of the piston-cylinder unit is of a diameter, with that diameter being in a ratio to a diameter of the at least one plasticizing screw of 0.5 to 1.1, preferably 0.8 to 1, particularly preferably 0.9.

9. A plasticizing unit as set forth in claim 1, wherein the at least one plasticizing screw is in the form of an individual plasticizing screw or in the form of a double-screw extruder.

10. A plasticizing unit as set forth in claim 1, wherein the plasticizing cylinder has at least one further opening at the periphery of the plasticizing cylinder and that at least one further opening connects the plasticizing cylinder to at least one further mass storage means, and wherein there is provided a further actuator for expelling a storage mass which can be stored in the at least one mass storage means, wherein preferably a longitudinal axis of the at least one further mass storage means and a longitudinal axis of the mass storage means are at an angle (2α) of 0° to 180° to each other.

11. A plasticizing unit as set forth in claim 1, wherein the at least one opening on the plasticizing cylinder is spaced from one end of the plasticizing cylinder, at which preferably the at least one discharge opening is arranged, by 0.2 to 4 times a diameter of the at least one plasticizing screw.

12. A plasticizing unit as set forth in claim 1, wherein the at least one mass storage means has a hydraulic and/or electrical actuation.

13. A plasticizing unit as set forth in claim 1, wherein there is provided at least one temperature-control device, preferably a heating device, wherein the at least one temperature-control device is adapted to temperature control a storage mass which can be stored in the at least one mass storage means.

14. A plasticizing unit as set forth in claim 1, wherein the actuator is adapted to specifically increase a volume of the at least one mass storage means for the feed of the plasticized material so that plasticized material can be conveyed out of the plasticizing cylinder by way of the at least one opening.

15. A shaping machine comprising a plasticizing unit as set forth in claim 1.

16. A method of operating a plasticizing unit as set forth in claim 1, including the following steps:
continuously plasticizing a material to be plasticized using the at least one plasticizing screw,
feeding plasticized material by way of the at least one opening in the plasticizing cylinder into the at least one mass storage means, and
expelling the storage mass out of the at least one mass storage means using the actuator, wherein plasticized material is expelled from the plasticizing unit.

17. A method as set forth in claim 16, wherein the actuator is actuated for the feed of the plasticized material to specifically increase a volume of the at least one mass storage means so that plasticized material is conveyed out of the plasticizing cylinder by way of the at least one opening.

18. A method as set forth in claim 16, wherein the actuator is actuated during the feed of the plasticized material in such way that substantially no plasticized material leaks from the plasticizing unit during a period of time of the feed.
